(19) United States
(12) Patent Application Publication
(10) Pub. No.: US 2010/0251848 A1
(43) Pub. Date: Oct. 7, 2010

(54) SERVO BRAKE

(75) Inventors: Peter Drott, Frankfurt (DE); Holger Von Hayn, Bad Vilbel (DE); Wolfgang Kroll, Ilofheim (DE); Volker Ickler, Kirchheim (DE); Thomas Sellinger, Offenbach (DE)

Correspondence Address: RATNERPRESTIA, P.O. BOX 980, VALLEY FORGE, PA, 19482, US

(73) Assignee: CONTINENTAL TEVES AG & CO. OHG, Frankurt (DE)

(21) Appl. No.: 12/667,068

(22) PCT Filed: May 20, 2008
(86) PCT No.: PCT/EP2008/056145

§ 371 Date: Jun. 15, 2010

(30) Foreign Application Priority Data
Jul. 4, 2007 (DE) 10 2007 031 255.7
Sep. 18, 2007 (DE) 10 2007 044 423.2

(51) Int. Cl. B60T 7/04; G05G 1/30; B60T 7/12; B60T 13/66; B60T 13/10

(52) U.S. Cl. 74/514

(57) ABSTRACT

A brake booster for a motor vehicle brake system of the “brake-by-wire” type, which can be activated, on the one hand, by a brake pedal and, on the other hand, as a function of a driver's request, as well as independently of the driver's will by an electronic control unit, wherein the coupling of the brake pedal to an input element of the brake booster is embodied by a piston rod head provided with longitudinal guide openings, in such a way that a limited relative movement of the brake pedal is possible with respect to the input element, as a result of which, in particular in the “brake-by-wire” operating mode, decoupling of the force-transmitting connection between the brake pedal and the input element is ensured.

The piston rod head is embodied as a U-shaped bent part which engages around the brake pedal.

### CROSS REFERENCE TO RELATED APPLICATIONS

This application is the U.S. national phase application of PCT International Application No. PCT/EP2008/056145, filed May 20, 2008, which claims priority to German Patent Application No. 10 2007 031 255.7, filed Jul. 4, 2007 and German Patent Application No. 10 2007 044 423.2, filed Sep. 18, 2007, the contents of such applications being incorporated by reference herein.

### BACKGROUND OF THE INVENTION

1. Field of the Invention

The invention relates to a brake booster for a motor vehicle brake system of the “brake-by-wire” type, which can be activated, on the one hand, by means of a brake pedal and, on the other hand, as a function of a driver's request, as well as independently of the driver's will by means of an electronic control unit, wherein the coupling of the brake pedal to an input element of the brake booster is embodied by means of a piston rod head provided with longitudinal guide openings, in such a way that a limited relative movement of the brake pedal is possible with respect to the input element, as a result of which, in particular in the “brake-by-wire” operating mode, decoupling of the force-transmitting connection between the brake pedal and the input element is ensured.

2. Description of Related Art

Such a brake booster is known from European Patent EP 0 417 945 B1. A piston rod which forms the input element of the previously known brake booster has a longitudinal guide opening which receives a bolt which is permanently connected to a brake pedal. The longitudinal guide opening permits a limited relative movement of the input element with respect to the bolt or the brake pedal, with the result that when the brake booster is used in a case of traction control or when the brake booster is actuated independently of the driver's will, the input element moves in the activation direction while the brake pedal remains stationary. However, the critical accessibility of the piston rod head in the passenger compartment of the motor vehicle, and the problems which occur when the brake pedal is installed in the passenger compartment, in particular when it is coupled to the input element of the brake booster, are felt to be disadvantageous.

### SUMMARY OF THE INVENTION

An object of the present invention is therefore to improve a brake booster of the generic type mentioned at the beginning with the effect that the disadvantages specified above are very largely avoided. Furthermore, the intention is to simplify the fabrication process of the brake booster.

This object is achieved according to aspects of the invention in that the piston rod head is embodied as a U-shaped bent part which engages around the brake pedal.

### BRIEF DESCRIPTION OF THE DRAWINGS

Further features and advantages of the invention emerge from the following description of two exemplary embodiments with reference to the appended drawing, in which:

FIG. 1 shows an activation unit of a motor vehicle brake system of the “brake-by-wire” type with a brake booster according to aspects of the invention in a side view;

FIG. 2 shows a three-dimensional illustration of a first embodiment of the piston rod head according to aspects of the invention;

FIGS. 3a and b show a simplified illustration of the fabrication of the piston rod head shown in FIG. 2;

FIG. 4 show three-dimensional illustrations of a second embodiment of the piston rod head according to aspects of the invention;

FIG. 5 shows a mounting step during the installation of the brake pedal or its connection to the piston rod head according to aspects of the invention according to FIG. 4a; and

FIG. 6 shows a three-dimensional illustration of the piston rod head according to aspects of the invention according to FIG. 4 with an installed brake pedal.

### DETAILED DESCRIPTION OF THE PREFERRED EMBODIMENTS

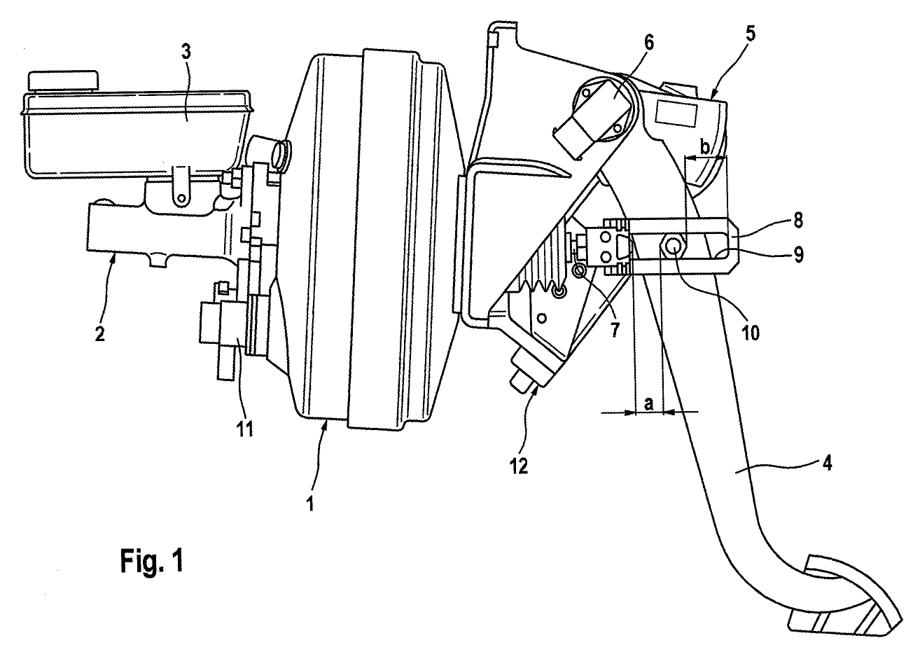

The activation unit illustrated in FIG. 1 is composed of a brake booster, preferably a partial vacuum brake booster 1, a master brake cylinder, preferably a tandem master cylinder 2 which is connected downstream of the brake booster 1 and to whose pressure spaces (not illustrated) wheel brakes of the motor vehicle are connected with intermediate connection of a hydraulic open-loop and closed-loop control unit (not illustrated either), and of a pressure medium reservoir vessel 3 which is assigned to the master brake cylinder 2. A brake pedal 4 is used by the driver to activate the brake booster 1, wherein a pedal travel simulator 5 (only indicated), which interacts with the brake pedal 4, in particular in the “brake-by-wire” operating mode, and conveys the customary brake pedal sensation to the driver, is provided. A driver's deceleration request or the activation travel of the brake pedal 4 is sensed by means of at least one sensor device 6, the signals of which are fed to an electronic control unit (not shown). The output signals of the electronic control unit can actuate, inter alia, an electromagnet which is assigned to the brake booster 1 and which permits a pneumatic control valve, which controls an air supply to the brake booster 1, to be activated independently of the driver's will.

A input element or a piston rod 7 which is coupled to the brake pedal 4 and which the driver uses to activate the previously mentioned control valve has a piston rod head 8 in which longitudinal guide openings 9 are formed. The longitudinal guide openings 9 receive a force-transmitting part 10 which is connected to the brake pedal 4 and which is embodied as a bolt. In this context, the abovementioned parts 8, 10 are arranged in such a way that an axial gap or distance “a” is provided between the boundary of the longitudinal guide openings 9 which is on the left-hand side in the drawing and the bolt 10, said gap or distance “a” ensuring decoupling of the force-transmitting connection between the brake pedal 4 and the brake booster 1 in the “brake-by-wire” operating mode. An axial gap or distance “b” provided between the bolt 10 and the boundary of the longitudinal guide openings 9 on the left-hand side in the drawing has the effect that when the brake booster 1 is actuated independently of the driver's will the brake pedal 4 is not also moved. A travel sensor 11 is used to sense the travel of a movable wall which applies the boosting force of the brake booster 1 and/or the travel of an output element of the brake booster 1 which transmits its output force to a first piston (not illustrated) of the master brake cylinder 2.

The pedal travel simulator 5, by means of which, as already mentioned, a restoring force, which acts on the brake pedal 4 in the “brake-by-wire” operating mode, can be simulated independently of activation of the brake booster 1, is embodied in such a way that, by means of an activation and deactivation device 12 (indicated only schematically), said pedal travel simulator 5 can be activated in the “brake-by-wire” operating mode when the force-transmitting connection between the brake pedal 4 and the brake booster 1 is decoupled, and can be deactivated outside the “brake-by-wire” operating mode.

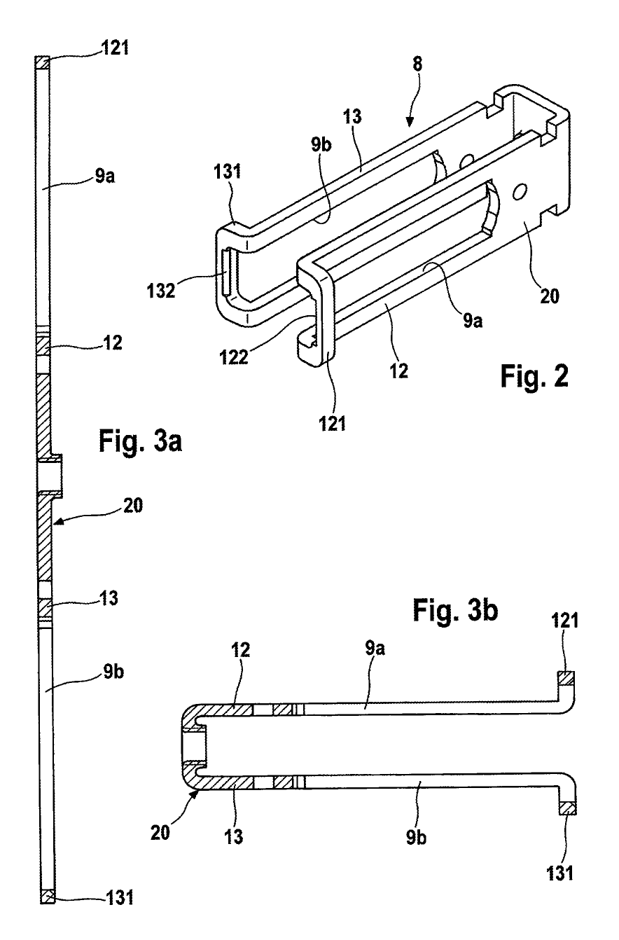

As is apparent in particular from FIG. 2 and FIGS. 3a and b, the piston rod head 8 which has been mentioned above is embodied as a U-shaped sheet-metal bent part 20 whose limbs 12, 13 engage around the brake pedal and have longitudinal guide openings 9a, 9b which are produced by punching before the bending process. The end regions 121, 131 of the limbs 12, 13 extend outward at an angle of approximately 90° and each have an insertion slope 122, 132, which insertion slopes 122, 132 are used to centre and position the bolt 10 during the assembly of the brake pedal 4. The aforesaid end regions 121, 131 can, as illustrated in the drawing, be produced by bending or by deep drawing.

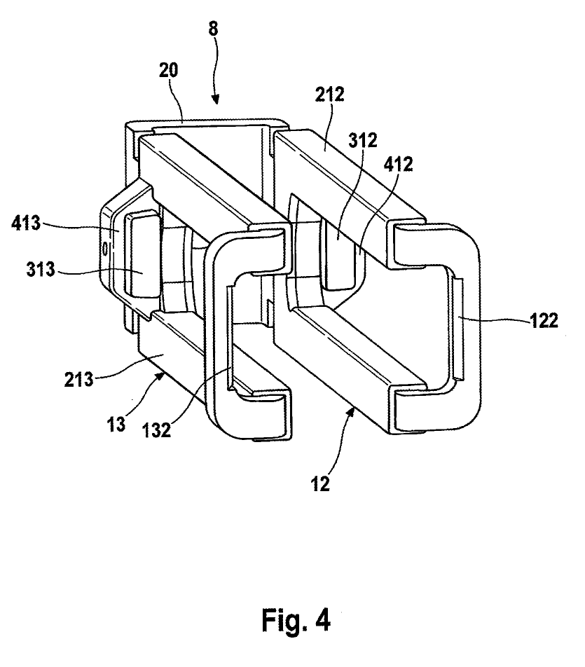

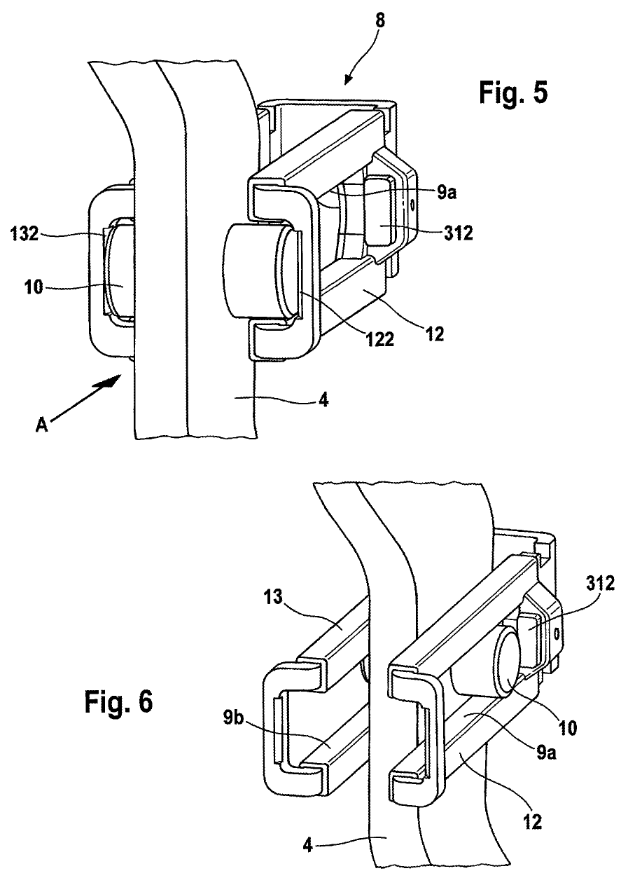

The embodiment of the inventive piston rod head 8 which is shown in FIG. 4 has, in the region of the limbs 12, 13, means which minimize the friction which occurs between the piston rod head 8 and the bolt 10 during their relative movement with respect to one another. The means are embodied in the example shown as a sheath 212, 213 made of plastic which has good sliding properties and with which the limbs 12, 13 are encapsulated by injection moulding in their sections which guide the bolt 10, and which make available the sliding faces for the bolt 10 within the longitudinal guide openings 9a, b. The abovementioned plastic at the same time forms securing elements 412, 413 for damping elements 312, 313 which serve to damp the impact of the bolt 10 at the end of its activation stroke. Alternatively, a single damping element (not illustrated) can be arranged in the front region of the piston rod head 8 between the limbs thereof. The bolt 10 (see in particular FIGS. 5 and 6) is permanently connected to the brake pedal 4 by means of a welded connection or a riveted connection, or is screwed to the brake pedal 4.

At the start of the mounting process (illustrated in simplified form in FIG. 5), for connecting the brake pedal 4 to the piston rod head 8 according to aspects of the invention, the piston rod head 8 is positioned with respect to the brake pedal 4 in such a way that the bolt 10 is located between the limbs 12, 13 in the region of the insertion slopes 122, 132. The brake pedal 4 is then threaded in in the direction of the arrow “A”, with the bolt 10 being guided within the longitudinal guide openings 9a, b. The movement of the bolt 10 within the longitudinal guide openings 9a, b is bounded by the damping elements 312, mentioned above in conjunction with FIG. 4. The assembled “brake pedal-piston rod head” module is illustrated in FIG. 6. After the brake device has been completely mounted, the pedal bolt no longer enters the region of the threading-in opening.

1.-15. (canceled)

16. Brake booster for a motor vehicle brake system of a “brake-by-wire” type, which can be activated by a brake pedal, as a function of a driver's request, and independently of a driver's will by an electronic control unit,
wherein a coupling of the brake pedal to an input element of the brake booster includes a piston rod head provided with longitudinal guide openings, such that a limited relative movement of the brake pedal is possible with respect to the input element, as a result of which, in a “brake-by-wire” operating mode, decoupling of a force-transmitting connection between the brake pedal and the input element is ensured,
wherein the piston rod head is embodied as a U-shaped bent part which engages around the brake pedal.

17. Brake booster according to claim 16, wherein an end of the piston rod head that faces away from the input element is of an open design.

18. Brake booster according to claim 16, wherein the piston rod head has two limbs which run parallel to one another and in which the longitudinal guide openings are formed as openings produced by punching.

19. Brake booster according to claim 18, wherein the limbs have, at an end of the longitudinal guide openings, connecting sections which are configured to ensure sufficient stability of the piston rod head.

20. Brake booster according to claim 18, wherein the longitudinal guide openings receive a bolt which is permanently connected to the brake pedal and which serves to transmit force between the brake pedal and the input element of the brake booster.

21. Brake booster according to claim 20, wherein the bolt is mounted on the brake pedal before installation of the brake pedal in the vehicle.

22. Brake booster according to claim 18, wherein end regions facing away from the input element of the limbs extend outward perpendicularly with respect to a longitudinal axis of the longitudinal guide openings for stability.

23. Brake booster according to claim 22, wherein the outward extending end regions of the limbs are produced by bending.

24. Brake booster according to claim 22, wherein the outward extending end regions of the limbs are produced by deep drawing.

25. Brake booster according to claim 20, wherein end regions facing away from the input element of the limbs are provided with stamped-on insertion slopes for centring and positioning the bolt during the assembly of the brake pedal.

26. Brake booster according to claim 20, wherein the piston rod head has, at an end of a movement range of the bolt, at least one elastic damping element for damping an impact of the bolt.

27. Brake booster according to claim 20, wherein the longitudinal guide openings or the bolt are provided with means which reduce friction occurring during relative movement of the bolt with respect to the piston rod head.

28. Brake booster according to claim 27, wherein the longitudinal guide openings are provided with a plastic lining.

29. Brake booster according to claim 27, wherein the bolt is provided with a plastic sheath.

30. Brake booster according to claim 27, wherein the limbs of the piston rod head are provided with a plastic sheath.

31. Brake booster according to claim 27, wherein the limbs of the piston rod head are encapsulated with plastic by injection moulding.

32. Brake booster according to claim 30, wherein the plastic sheath of the limbs forms securing elements which hold the at least one elastic damping element.
